(19) United States
(12) Patent Application Publication
(10) Pub. No.: US 2019/0191418 A1
(43) Pub. Date: Jun. 20, 2019

(54) METHOD AND APPARATUS FOR OBTAINING CONTROL INFORMATION

(71) Applicant: Electronics and Telecommunications Research Institute, Daejeon (KR)

(72) Inventors: Jung Sun UM, Daejeon (KR); Seung Keun PARK, Daejeon (KR)

(73) Assignee: Electronics and Telecommunications Research Institute, Daejeon (KR)

(21) Appl. No.: 15/938,431

(22) Filed: Mar. 28, 2018

(30) Foreign Application Priority Data
Dec. 18, 2017 (KR) 10-2017-0174427

(51) Int. Cl. H04W 72/04

(52) U.S. Cl. CPC H04W 72/042; H04W 72/044

(57) ABSTRACT

Provided is a method and apparatus for obtaining control information. A control information obtaining apparatus may receive wireless signals corresponding to different center frequencies from a plurality of cells, may estimate scheduling information from the wireless signals; and may obtain control information about a downlink of the plurality of cells based on the scheduling information.

### CROSS-REFERENCE TO RELATED APPLICATION(S)

This application claims the priority benefit of Korean Patent Application No. 10-2017-0174427 filed on Dec. 18, 2017 in the Korean Intellectual Property Office, the disclosures of which are incorporated herein by reference for all purposes.

### BACKGROUND

### 1. Field

At least one example embodiment relates to a method and apparatus for obtaining control information.

### 2. Description of Related Art

A long term evolution (LTE) mobile communication system provides a voice/data wireless communication service using orthogonal frequency division multiplexing (OFDM). Any type of service information, such as voice and data, transferred to a terminal may be referred to as user traffic. The user traffic is divided based on a 1 ms unit subframe. The user traffic divided into the respective subframes is transferred from a base station to a terminal through a downlink data channel of LTE, such as a physical downlink shared channel (PDSCH). A single subframe may include a plurality of PDSCHs. Downlink control information (DCI), such as a configuration location within a bandwidth of each PDSCH and digital modulation information of such divided user traffic, is transmitted through an LTE downlink control channel, such as a physical downlink control channel (PDCCH) that is provided in the same subframe as the PDSCH. Various types of DCI may be present based on the purpose of control information.

### SUMMARY

At least one example embodiment provides a control information obtaining method and apparatus that may validly obtain control information of a downlink of a mobile communication network under condition that a radio resource control (RRC) connection is absent.

According to an example embodiment, there is provided a method of obtaining control information, the method including receiving wireless signals corresponding to different center frequencies from a plurality of cells; estimating scheduling information from the wireless signals; and obtaining control information about a downlink of the plurality of cells based on the scheduling information.

The estimating of the scheduling information may include estimating relationship information between downlink control information (DCI) of a physical downlink control channel (PDCCH) area and a resource block (RB) of a physical downlink shared channel (PDSCH) area included in each of the wireless signals as the scheduling information.

The estimating of the scheduling information may include estimating DCI within the PDCCH area from reception data of the PDCCH area included in each of the wireless signals; estimating at least one of occupancy or non-occupancy of an RB within the PDSCH area included in each of the wireless signals and a modulation scheme of the RB from reception data of the PDSCH area included in each of the wireless signals; and estimating relationship information between the DCI and the RB based on the DCI within the PDCCH area and the RB within the PDSCH area.

The estimating of the scheduling information may include a first operation of verifying an RB of a PDSCH area corresponding to valid DCI in a PDCCH area of a serving cell; a second operation of verifying DCI not corresponding to the RB of the PDSCH area from DCI within the PDCCH area of the serving cell and an RB not corresponding to the DCI of the PDCCH area from RBs within the PDSCH area; a third operation of repeating the first operation and the second operation with respect to the plurality of cells; and a fourth operation of verifying correspondence relationship between the DCI verified to not correspond and the RB verified to not correspond in the second operation, based on an RB allocation location included in the DCI verified to not correspond in the second operation.

The estimating of the scheduling information may further include a fifth operation of updating a field value of a carrier indicator field (CIF) per cell-radio network temporary identifier (C-RNTI) that allows the DCI including the CIF to be received during a data valid section of the wireless signals.

The DCI verified to not correspond and the RB verified to not correspond may be based on cross-carrier scheduling.

The estimating of the scheduling information may include estimating, as the scheduling information, a transport block size (TBS) that is a size of service data transferred through a PDSCH, based on a number of RBs allocated to a terminal and a TBS index corresponding to DCI of a PDCCH area included in each of the wireless signals.

The TBS index may be determined based on a modulation coding scheme (MCS) field value within the DCI, a modulation scheme of an RB, and information about an MCS table.

Information about the MCS table may be determined based on the modulation scheme of the RB.

Information about the MCS table may be determined based on the MCS field value and the modulation scheme of the RB if the MCS field value meets a predetermined condition.

Information about the MCS table may be determined based on a weight applied to each of a plurality of MCS tables.

The weight may be determined based on at least one of at least one of a distribution rate and a use rate of a terminal supporting a specific modulation scheme; a size of a precoding index field of DCI; a number of retransmissions of a single RNTI during a plurality of sub-frame sections; and a distance between a base station and the terminal.

According to an example embodiment, there is provided a method of obtaining control information, the method including receiving wireless signals corresponding to different center frequencies from a plurality of cells; estimating relationship information between DCI of a PDCCH area and an RB of a PDSCH area included in each of the wireless signals; and obtaining control information about a downlink of the plurality of cells based on the relationship information.

According to an example embodiment, there is provided an apparatus for obtaining control information, the apparatus including a processor; and a memory including at least one instruction executable by the processor. When the at least one instruction is executed by the processor, the processor is configured to receive wireless signals corresponding to different center frequencies from a plurality of cells, to estimate scheduling information from the wireless signals, and to obtain control information about a downlink of the plurality of cells based on the scheduling information.

The processor may be configured to estimate relationship information between DCI of a PDCCH area and an RB of a PDSCH area included in each of the wireless signals as the scheduling information.

The processor may be configured to estimate DCI within the PDCCH area from reception data of the PDCCH area included in each of the wireless signals, to estimate at least one of occupancy or non-occupancy of an RB within the PDSCH area included in each of the wireless signals and a modulation scheme of the RB from reception data of the PDSCH area included in each of the wireless signals, and to estimate relationship information between the DCI and the RB based on the DCI within the PDCCH area and the RB within the PDSCH area.

The processor may be configured to estimate, as the scheduling information, a TBS that is a size of service data transferred to a PDSCH, based on a number of RBs allocated to a terminal and a TBS index corresponding to DCI of a PDCCH area included in each of the wireless signals.

The TBS index may be determined based on a modulation coding scheme (MCS) field value within the DCI, a modulation scheme of the RB, and information about an MCS table.

Information about the MCS table may be determined based on the MCS field value and the modulation scheme of the RB if the MCS field value meets a predetermined condition.

Information about the MCS table may be determined based on a weight applied to each of a plurality of MCS tables.

According to example embodiments, under condition that an RRC connection is absent, a control information obtaining apparatus may validly obtain control information of a downlink of a mobile communication network.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration of a control information obtaining apparatus according to an example embodiment;

FIG. 2 is a diagram illustrating a configuration of a signal receiver according to an example embodiment;

FIG. 3 illustrates an example of describing an operation of a signal processor according to an example embodiment;

FIG. 4 illustrates an example of describing a map between downlink control information (DCI) and a resource block (RB) according to an example embodiment;

FIG. 5 illustrates an example of describing relationship information between DCI and an RB according to an example embodiment;

FIGS. 6 and 7 illustrate examples of a process of determining information about a modulation coding scheme (MCS) table according to an example embodiment;

FIG. 8 is a flowchart illustrating an example of a control information obtaining method according to an example embodiment; and

FIG. 9 is a diagram illustrating an example of a control information obtaining apparatus according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments applied to a mobile communication network will be described. It is provided as an example only and the example embodiments may be applicable to various networks.

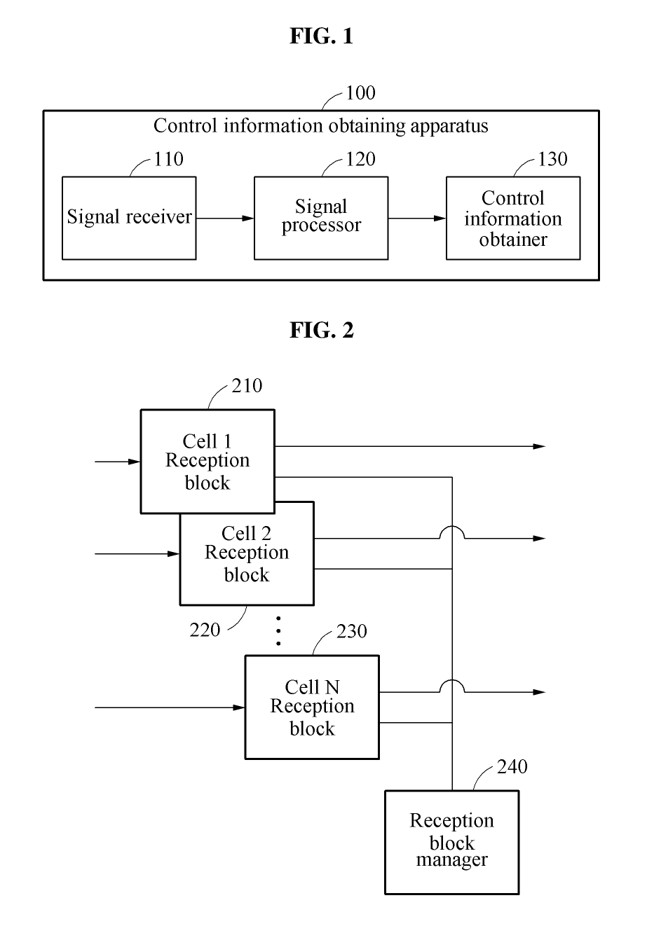

FIG. 1 is a diagram illustrating a configuration of a control information obtaining apparatus according to an example embodiment.

The example embodiments relate to technology for obtaining mobile communication service related data from a downlink or an uplink of a cell managed or operated by a base station in a state in which a radio resource control (RRC) connection is absent in a mobile communication network. In detail, the example embodiments relate to a method and apparatus for obtaining control information of a downlink under condition that an RRC message or RRC information transferred using the RRC connection is absent.

Initially, an example in which the RRC connection is present will be described. If the RRC connection is present, a cell-radio network temporary identifier (C-RNTI) may be assigned from a cell to a terminal. A base station may include and thereby transmit 16-bit cyclic redundancy check (CRC) in downlink control information (DCI) so that the terminal may verify a reception error of the DCI. Here, an RNTI of the terminal that is to receive DCI may be operated or masked as Exclusive OR in CRC. Accordingly, the terminal may verify a CRC error using the RNTI and may obtain DCI that is transferred to the terminal among a plurality of pieces of DCI.

In a mobile communication system, for example, a long term evolution (LTE) system, a single component carrier (CC) may have a maximum bandwidth of 20 megahertz (MHz). According to an increase in traffic to be transferred to the terminal, the mobile communication system may employ carrier aggregation (CA) technology for simultaneously using a plurality of carriers. The mobile communication system may perform cross-carrier scheduling of transmitting DCI about a physical downlink shared channel (PDSCH) configured in a specific carrier using a physical downlink control channel (PDCCH) of another carrier through carrier aggregation. In this case, 3 bits of a carrier indicator field (CIF) indicating control information about which carrier may be included in DCI. An index of a carrier designated by each bit may be defined in order of CA-configured carriers for each terminal. Accordingly, an index value indicating the same carrier may be different for each terminal.

Quadrature phase shift keying (QPSK), 16 quadrature amplitude modulation (16QAM), 64QAM, and 256QAM may be applicable as a modulation scheme employed for digital modulation of mobile communication downlink data. A modulation scheme applied for a PDSCH may be defined in an MCS field within DCI of a corresponding PDCCH and thereby transferred to a terminal. The MCS field may include 5 bits. The terminal may determine a transport block size (TBS) that is a size of service data transferred through a PDSCH based on an MCS field value and a number of RBs allocated to the terminal. In detail, the TBS may be determined based on a number of RBs and a TBS index corresponding to an MCS field value by referring to an MCS table promised between the base station and the terminal. The MCS table may include a first MCS table defined up to maximum 64QAM and a second MCS table defined up to maximum 256QAM. An MCS table used between the two MCS tables, for example, the first MCS table and the second MCS table may be easily known by an RRC message or RRC signaling.

In general, in a state in which an RRC connection is absent, information transferred using an RRC message, such as an RNTI, a CIF, an MCS table, and the like, may not be obtained. However, proposed herein is a method and apparatus for obtaining control information of a specific cell without using the RRC connection.

Referring to FIG. 1, a control information obtaining apparatus 100 includes a signal receiver 110, a signal processor 120, and a control information obtainer 130.

The signal receiver 110 receives wireless signals from a plurality of cells. Here, the wireless signals received from the plurality of cells may have different center frequencies. The signal processor 120 estimates scheduling information from the wireless signals. The scheduling information may include relationship information relationship information between DCI of a PDCCH area and an RB of a PDSCH area included in each of the wireless signals and a TBS that is a size of service data transferred through a PDSCH. The control information obtainer 130 obtains control information about a downlink of the plurality of cells based on the scheduling information. Here, the control information may include, for example, a current operation state of a cell, a current management state, and/or a statistical characteristic thereof as mobile communication service related data extracted from a downlink of a cell managed or operated by the base station. For example, the control information may indicate information (e.g., a control information field within DCI and a number of information bits of each field) included in DCI within the PDCCH area. Examples of a DCI format 1 may be provided as shown in the following Table 1.

TABLE 1

| BW | 1.4 MHz | 3 MHz | 5 MHz | 10 MHz | 15 MHz | 20 MHz |
|---|---|---|---|---|---|---|
| Carrier Indicator Field | 3 | 3 | 3 | 3 | 3 | 3 |
| Resource allocation header | 0 | 1 | 1 | 1 | 1 | 1 |
| Resource block assignment | 6 | 8 | 13 | 17 | 19 | 25 |
| 1) Resource allocation type 0 | | | | | | |
| Resource allocation | 6 | 8 | 13 | 17 | 19 | 25 |
| 2) Resource allocation type 1 | | | | | | |
| Resource block subset | 0 | 1 | 1 | 2 | 2 | 2 |
| Shift of the resource allocation span | 1 | 1 | 1 | 1 | 1 | 1 |
| Resource allocation | 5 | 6 | 11 | 14 | 16 | 22 |
| Modulation and coding scheme | 5 | 5 | 5 | 5 | 5 | 5 |
| HARQ process | 3 | 3 | 3 | 3 | 3 | 3 |
| New data indicator | 1 | 1 | 1 | 1 | 1 | 1 |
| Redundancy version | 2 | 2 | 2 | 2 | 2 | 2 |
| TPC command for PUCCH | 2 | 2 | 2 | 2 | 2 | 2 |
| Downlink assignment index | 0 | 0 | 0 | 0 | 0 | 0 |
| Padding bit | 0 | 0 | 0 | 0 | 0 | 0 |
| Total | 22 | 25 | 30 | 34 | 36 | 42 |

DCI format 1 may be used to transfer resource allocation and data transmission information about a single PDSCH. A number of information bits occupied by each control information field (element) of DCI format 1 may be defined based on the bandwidth. Table 1 assumes a frequency division duplex (FDD) transmission scheme, and a number of bits of a downlink assignment index used for a time division duplex (TDD) may be zero. Resource block assignment and MCS information may be most associated with the present disclosure among fields collected by the control information obtaining apparatus 100. The resource block assignment may represent a number of RBs allocated to each terminal and a location in a frequency domain. The MCS information may be bit size information transmitted as information that enables a corresponding terminal to verify a TBS index with the number of RBs allocated to the terminal. The resource block assignment and the MCS information may be used to calculate a transmission rate and a number of RBs allocated during a desired period of time in an operation bandwidth of each cell. Accordingly, whether operable capacity of a cell is saturated may be analyzed and a current operation state, such as a frequency efficiency of a cell, may be analyzed from the transmitted bit information. Also, a statistical characteristic may be analyzed from the aforementioned information.

Hereinafter, the control information obtaining apparatus 100 will be further described with reference to the accompanying drawings.

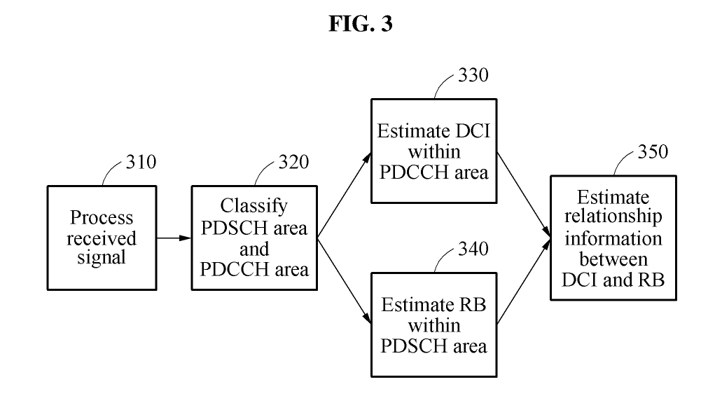

FIG. 2 is a diagram illustrating a configuration of a signal receiver according to an example embodiment.

Referring to FIG. 2, the signal receiver may include a plurality of reception blocks 210, 220, and 230, and a reception block manager 240. The signal receiver may receive a wireless signal of a downlink.

Each of the plurality of reception blocks 210, 220, and 230 may independently have a number of reception paths corresponding to a number of carrier aggregations (CAs). Each of the reception blocks 210, 220, and 230 with respect to N cells having different center frequencies may receive and store a wireless signal during a predetermined period of time or may receive a wireless signal in real time. For example, each of the plurality of reception blocks 210, 220, and 230 may include a signal storage, a signal synchronizer, and a channel estimator, and may process and manage a wireless signal at desired time intervals. Each of the plurality of reception blocks 210, 220, and 230 may identify a wireless signal based on a subframe unit and may distinguish data about a PDDCH area and data about a PDSCH area of each subframe.

The reception block manager 240 may manage the plurality of reception blocks 210, 220, and 230. The reception block manager 240 may control a time for storing a wireless signal received from each of N cells or may store and manage information about N cells, such as reception block synchronization time point information that is processed in real time.

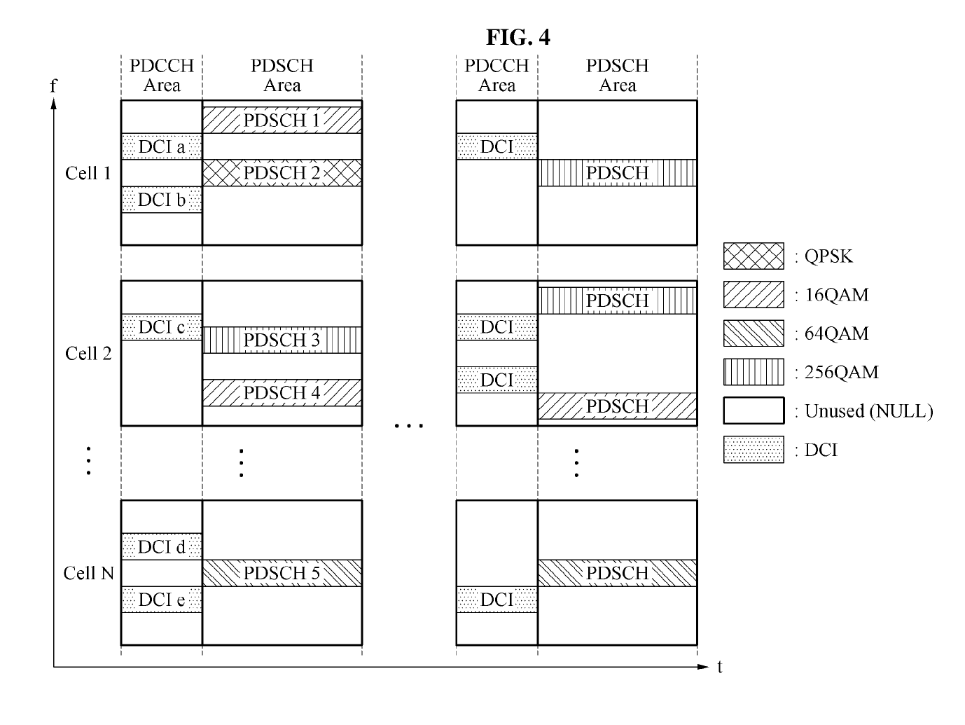

FIG. 3 is a diagram illustrating an example of describing an operation of a signal processor according to an example embodiment.

Referring to FIG. 3, the signal processor may perform digital signal processing on a received wireless signal. Control information may be obtained by a control information obtainer based on data that is signal processed at the signal processor.

In operation 310, the signal processor may digitally process wireless signals transferred from a signal receiver. For example, the signal processor may perform at least one process of processing the wireless signals to be suitable for estimating scheduling information.

In operation 320, the signal processor may classify each of the wireless signals based on a predetermined time unit or a predetermined item unit. For example, the time unit may be a subframe and the item unit may be a PDCCH area and a PDSCH area.

In operation 330, the signal processor may estimate DCI masked with a specific RNTI from data of the PDCCH area.

In operation 340, the signal processor may estimate at least one of occupancy or non-occupancy and a modulation scheme for each RB from data of the PDSCH area. That is, an RB state of a PDSCH area, such as an occupancy state, a modulation scheme, a spatial multiplexing state of an RB, etc., may be estimated based on subcarrier symbols or data in which a channel is compensated in the PDSCH area. The modulation scheme of the RB indicates a modulation order and may be estimated based on a saturation level of in-phase, quadrature phase for each predefined modulation order or a distribution threshold range for each modulation order.

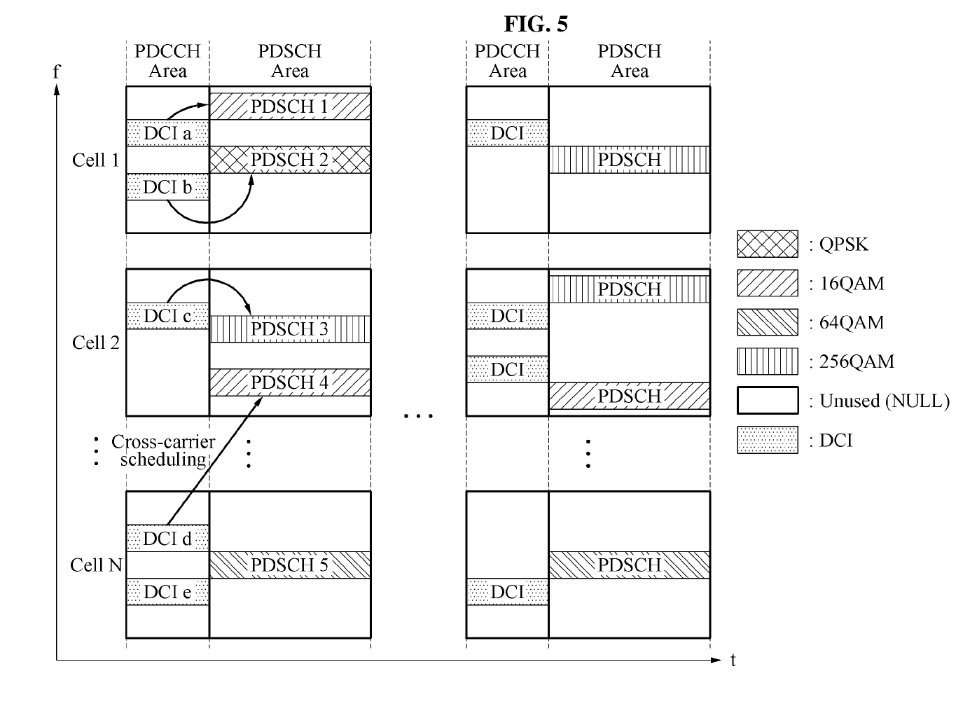

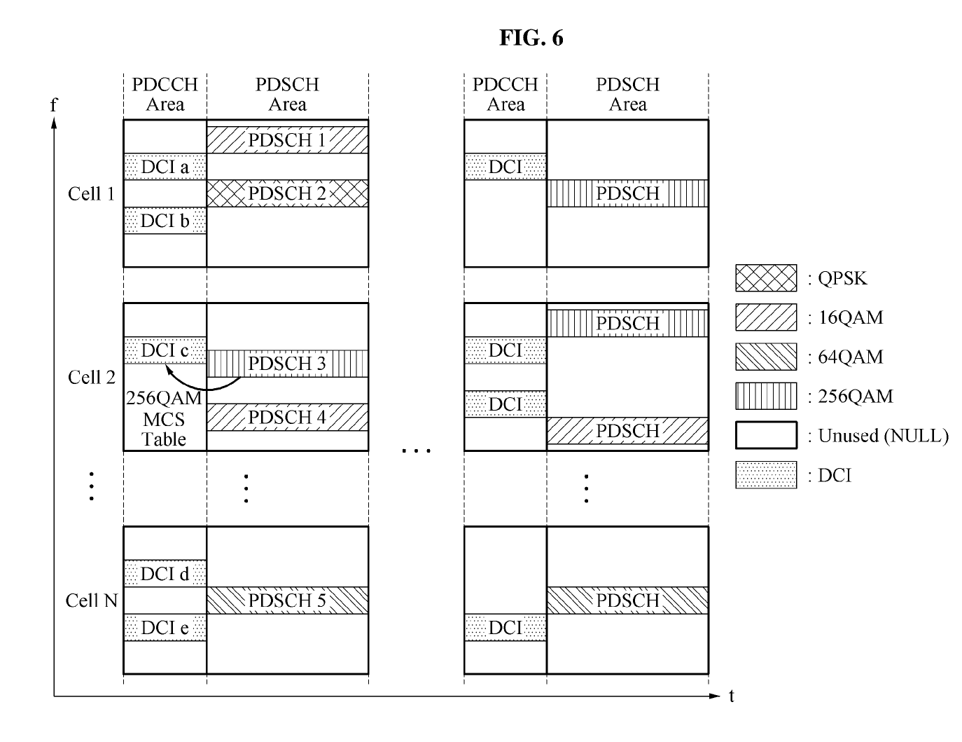

In operation 350, the signal processor may estimate relationship information between the DCI and the RB based on the estimation result of operation 340. The relationship information between the DCI and the RB will be further described with reference to FIGS. 4 and 5.

FIG. 4 illustrates an example of describing a map between DCI and an RB according to an example embodiment.

An example of a map between DCI and an RB estimated at a signal processor according to an example embodiment will be described with reference to FIG. 4.

According to an example embodiment, control information may be obtained based on relationship information between DCI of a PDCCH area and an RB of a PDSCH area. That is, control information may be obtained by using relationship information under condition that an RRC connection is absent. The relationship information may be provided based on the map between the DCI and the RB of FIG. 4, and may be acquired by logically connecting the DCI of the PDCCH area and the RB of the PDSCH.

In FIG. 4, an x axis denotes a time and a y axis denotes a center frequency. A subframe may include a single PDCCH area and a PDSCH area corresponding thereto. At least one piece of DCI may be included in the PDCCH area and at least one allocated or scheduled RB corresponding to the DCI may be included in the PDSCH area. Hereinafter, an RB may be understood as an RB allocated to a terminal. Referring to FIG. 4, within the PDSCH area, “PDSCH 1” may correspond to “RB 1” and “PDSCH 2” may correspond to “RB 2”. Accordingly, “PDSCH n” within the PDSCH area may correspond to “RB n”. Here, a number of actually configured physical RBs may be different for each of RB 1, RB 2, . . . , RB n. A modulation scheme of each RB may be set using one of QPSK, 16QAM, 64QAM, and 256QAM.

Dissimilar to the example of FIG. 4, the modulation scheme of the RB within the PDSCH area may be represented using a number. For example, an unused RB may be defined as 0, QPSK may be defined as 1, 16QAM may be defined as 2, 64QAM may be defined as 3, and 256QAM may be defined as 4.

According to an example embodiment, a control information obtainer may obtain control information based on scheduling information estimated at the signal processor. For example, the control information obtainer may obtain a current operation state of each cell, a current management state thereof, and/or a statistical characteristic thereof as the control information.

Fields of DCI within the PDCCH area may include a field from which data is immediately obtainable and a field that varies based on an RRC message. Some fields of DCI associated with the RRC message may be accurately estimated from an RB state within the PDSCH area estimated at the signal processor. Hereinafter, a CIF and an MCS corresponding to such fields will be further described. The CIF and the MCS may be a field associated with frequency aggregation.

FIG. 5 illustrates an example of describing relationship information between DCI and an RB according to an example embodiment.

According to an example embodiment, in a mobile communication system, a single component carrier (CC) may include a maximum bandwidth of 20 MHz. As traffic to be transferred to a terminal increases, the mobile communication system may employ carrier aggregation (CA) technology for simultaneously using a plurality of carriers. An index for carriers configured through CA may be designated and managed using ‘ServCellIndex’. A cell configured through an initial connection between the terminal and a network is referred to as a primary cell (PCell). Here, a ServCellIndex value becomes ‘zero’. A cell additionally configured with respect to the terminal by a base station is referred to as a secondary cell (SCell). Here, ServCellIndex may sequentially increase. Accordingly, each terminal may have a different cell index value.

The mobile communication system may employ cross-carrier scheduling of transmitting DCI about a PDSCH configured in a specific carrier using a PDCCH of another carrier through CA. Through the cross-carrier scheduling, the mobile communication system may transmit DCI about a PDSCH of another SCell from PCell or may transmit DCI about a PDSCH of another SCell aside from the SCell. Here, a single carrier may be defined as a single cell.

In general, whether to perform cross-carrier scheduling may be configured in the terminal using an RRC message. The RRC message associated with the cross-carrier scheduling may include information regarding from which cell DCI about a PDSCH of a specific cell is transmitted. The terminal in which the cross-carrier scheduling is configured needs to know a PDSCH of a cell that is indicated by DCI. Accordingly, a 3-bit CIF indicating the PDSCH of the corresponding cell may be included in the DCI. A cell indicated by a field value of a CIF may have the same value as that of ‘ServCellIndex’. Accordingly, the following procedure needs to be performed so that a control information obtaining apparatus may discover the PDSCH of the corresponding cell indicated by the field value of the CIF under condition in which an RRC connection is absent.

In a first operation, an RB of a PDSCH area corresponding to valid DCI within a PDCCH area of a serving cell may be verified. Whether DCI of the PDCCH area and the RB of the PDSCH area corresponding to the same cell correspond to each other may be verified. For example, referring to FIG. 5, it can be verified that, within a PDCCH area corresponding to cell 1, DCI a corresponds to a PDSCH 1 and DCI b corresponds to a PDSCH 2. Correspondence relationship between DCI of the PDCCH area and an RB of the PDSCH area corresponding to the same cell may be based on self-scheduling.

In a second operation, DCI not corresponding to the RB of the PDSCH area from DCI within the PDCCH area of the serving cell may be verified. Also, an RB not corresponding to DCI of the PDCCH area from RBs within the PDSCH of the serving cell may be verified. For example, referring to FIG. 5, a PDSCH 4 may be verified from a cell 2 and DCI d may be verified from a cell N.

In a third operation, the first operation and the second operation may be repeated with respect to a plurality of cells. Accordingly, it can be verified that DCI c within the PDCCH area corresponding to the cell 2 corresponds to a PDSCH 3 and DCI e within the PDCCH area corresponding to the cell N corresponds to a PDSCH 5.

In a fourth operation, correspondence relationship between the DCI verified to not correspond and the RB verified to not correspond in the second operation, based on an RB allocation location included in the DCI verified to not correspond in the second operation may be verified. For example, referring to FIG. 5, it can be verified that DCI d within the PDCCH area of the cell N corresponds to the PDSCH 4 within the PDSCH area of the cell 2. That is, in the fourth operation, the correspondence relationship between the DCI and the RB based on the cross-carrier scheduling may be verified.

In a fifth operation, a field value of a CIF per C-RNIT that allows DCI including the CIF to be received through the first through fourth operations during a data valid section of the wireless signals may be updated.

According to an example embodiment, a PDSCH of a cell that is indicated by a field value of a CIF may be verified from an RB state of a PDSCH area, estimated at the signal processor. Also, service information may be obtained through cross-scheduling in terms of obtaining cell operation information.

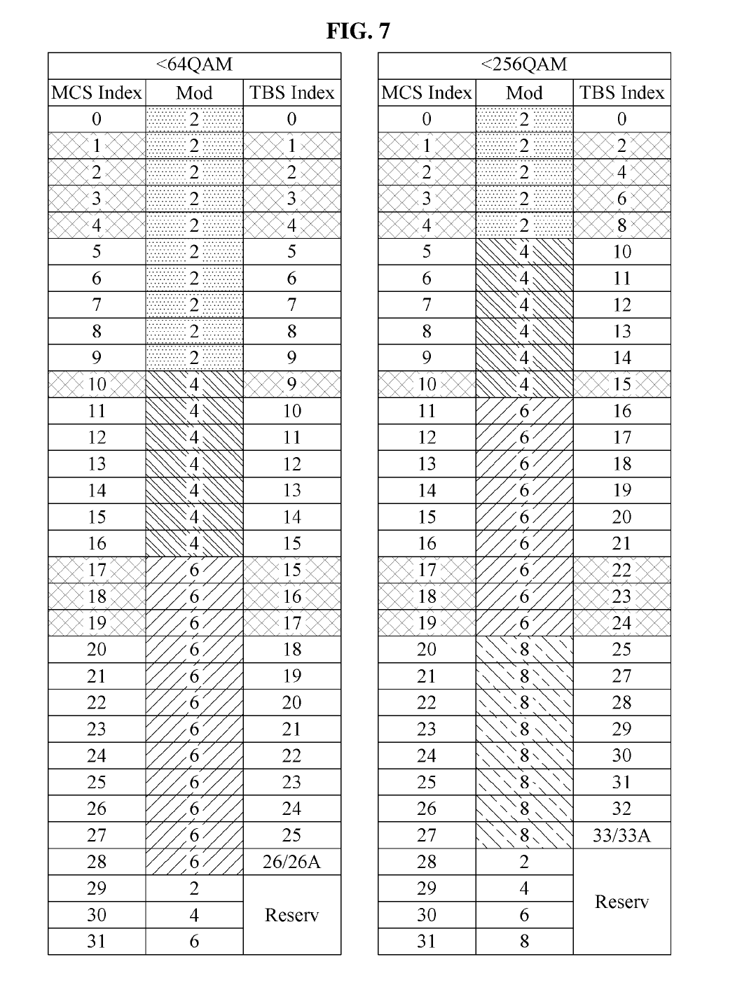

FIGS. 6 and 7 illustrate examples of a process of determining information about a modulation coding scheme (MCS) table according to an example embodiment.

Downlink data of a mobile communication network may be modulated based on at least one of QPSK, 16QAM, 64QAM, and 256QAM. Here, 256QAM was not supported at an early stage of the mobile communication network, however, has become available at a later stage. A modulation order applied to a PDSCH may be defined in an MCS field of DCI within a corresponding PDCCH area. The MCS field of the DCI may include 5 bits. A TBS that is a size of service data to be transferred using the PDSCH may be estimated based on an MCS field value and a number of RBs allocated to the terminal. In detail, the TBS may be estimated based on a number of RBs and a TBS index corresponding to an MCS field value by referring to an MCS table promised between a base station and the terminal. The MCS table may include two types of MCS tables, for example, a first MCS table defined up to maximum 64QAM and a second MCS table defined up to maximum 256QAM.

In general, the terminal may be aware of an MCS table used between the two MCS tables, for example, the first MCS table and the second MCS table, based on an RRC message or RRC signaling. Accordingly, the following method may be used so that the control information obtaining apparatus may be aware of the MCS table being used under condition that an RRC connection is absent.

Herein, regarding an MCS table selection, proposed are a selection method based on an RB state of a PDSCH area and a probability-based selection method.

Initially, regarding the selection method based on the RB state of the PDSCH, once the RB state of the PDSCH is estimated at the signal processor, a modulation order of each RB may be verified. FIG. 6 illustrates an example of determining information about an MCS table based on a modulation scheme of an RB. Referring to FIG. 6, within a PDSCH area of a cell 2, a modulation scheme of a PDSCH 3 may be estimated as 256QAM and an MCS field value of DCI c corresponding to the PDSCH 3 may be estimated to indicate an MCS table, for example, a second MCS table, defined up to maximum 256QAM. That is, an MCS table that is indicated by an MCS field value within DCI corresponding to a corresponding PDSCH may be estimated based on an RB modulation scheme of the PDSCH. Accordingly, although the RRC connection is absent, the control information obtaining apparatus may be aware of information about the MCS table indicated by the MCS field value of DCI.

Here, if the modulation scheme is not 256QAM, an MCS table that is indicated by the MCS field value may be unknown. In this case, information about the MCS table may be determined based on the following method.

FIG. 7 illustrates an example of a first MCS table defined up to maximum 64QAM and a second MCS table defined up to maximum 256QAM. Referring to FIG. 7, “<64QAM” may represent the first MCS table defined up to 64QAM and “<256QAM” may represent the second MCS table defined up to 256QAM.

In each MCS table, “MCS Index” denotes an MCS field value, “Mod” denotes a modulation order, and “TBS Index” denotes a TBS index. Here, Mod=2 represents QPSK, Mod=4 represents 16QAM, Mod=6 represents 64QAM, and Mod=8 represents 256QAM.

In the two MCS tables, for example, the first MCS table and the second MCS table, of FIG. 7, the same MCS field values, that is, indices corresponding to the same modulation order are represented using a lattice and no marking is made on an MCS field value corresponding to a different modulation order.

In this aspect, if an MCS field value meets a predetermined condition, information about an MCS table may be determined based on the MCS field value and a modulation scheme of an RB. For example, if the MCS field value corresponds to 5˜9, 11˜16, and 20˜28, an MCS table currently being used may be determined between the two MCS tables, for example, the first MCS table and the second MCS table, based on the MCS field value and the modulation scheme of the RB. A type of an MCS table may be determined based on single-subframe extraction information, or may be determined based on multi-subframe extraction information.

The probability-based selection method may determine a TBS by applying a weight to at least one of the two MCS tables, for example, the first MCS table and the second MCS table, based on statistical characteristic information. Here, the weight may correspond to an occurrence probability of each of the two MCS tables. The weight may be applied to the two MCS tables based on a characteristic of information to be obtained at the control information obtainer.

For example, it is assumed that an amount of transmitted service data is collected from TBS size information for each terminal or each RNTI. If an MCS table is not determined using the selection method based on the RB state of the PDSCH through a single subframe or a plurality of subframes, the probability-based selection method may be performed. In the probability-based selection method, a TBS index corresponding to an MCS field value may be determined in each of the two MCS tables, for example, the first MCS table and the second MCS table. Two TBS sizes may be determined based on the determined two TBS indices and the number of RBs allocated to the terminal. A size of service data transmitted using the PDSCH may be finally determined by applying weights of the two MCS tables to the determined TBS sizes.

As another example, a single MCS table to be used for obtaining control information may be selected from between the two MCS tables, for example, the first MCS table and the second MCS table, based on a weight. A size of service data may be finally determined by determining a TBS size based on the MCS table selected from between the two MCS tables.

In the aforementioned probability-based selection method, the weight may be determined based on at least one of the following elements.

First, the weight may be determined based on a distribution rate and a use rate of a terminal supporting a specific modulation scheme. Here, the specific modulation scheme may refer to 256QAM. The MCS table, for example, the second MCS table, defined up to maximum 256QAM is applicable only to a terminal supporting a new standard, for example, 256QAM. The weight may be determined based on at least one of a ratio of a use rate and a distribution rate of the terminal supporting 256QAM.

Second, the weight may be determined based on a size of a precoding index field of DCI. The precoding index field may have a different bit size depending on whether a number of transmission and reception antennas is 2 or 4. Accordingly, if the number of transmission and reception antennas is 4, a probability of the terminal supporting 256QAM may increase. Using this, the weight may be determined.

Third, the weight may be determined based on a number of retransmissions of a single RNTI during a plurality of subframe sections. Referring to the two MCS tables, for example, the first MCS table and the second MCS table, of FIG. 7, a TBS index of the MCS table, for example, the second MCS table, defined up to maximum 256QAM has a relatively great value among TBS indices corresponding to the same MCS index. A channel coding rate relatively increases and an error occurrence probability also increases. Accordingly, a weight of an MCS table may be determined based on a ratio of the number of retransmissions to the single RNTI during the plurality of subframe sections. The weight may be deduced from relative retransmission statistical values of 64QAM table and 256QAM table among PDSCHs within the same cell. That is, the control information obtainer may include a function of extracting retransmission ratio information according to an MCS table.

Fourth, the weight may be determined based on a distance between the base station and the terminal. According to a decrease in the distance between a location of the base station and a location of the terminal, strength of a received wireless signal may increase and accordingly, relatively excellent reception quality may be achieved. If estimating a size of transmitted service data is intended, a relatively high transmission rate may be expected according to a relatively excellent channel quality. Accordingly, a size of transmitted service data may be estimated by increasing the weight of the MCS table, the second MCS table, defined up to maximum 256QAM between the two MCS tables, for example, the first MCS table and the second MCS table, based on the distance.

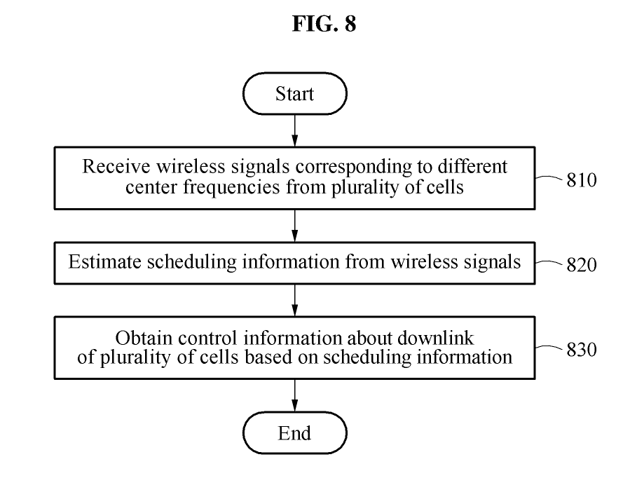

FIG. 8 is a flowchart illustrating an example of a control information obtaining method according to an example embodiment.

The control information obtaining method may be performed by a processor of a control information obtaining apparatus according to an example embodiment.

Referring to FIG. 8, in operation 810, the control information obtaining apparatus receives wireless signals corresponding to different center frequencies from a plurality of cells.

In operation 820, the control information obtaining apparatus estimates scheduling information from the wireless signals.

According to an example embodiment, the control information obtaining apparatus may estimate relationship information between DCI of a PDCCH area and an RB of a PDSCH area included in each of the wireless signals as the scheduling information. The control information obtaining apparatus may estimate DCI within the PDCCH area from reception data of the PDCCH area included in each of the wireless signals, may estimate at least one of occupancy or non-occupancy of an RB within the PDSCH area included in each of the wireless signals and a modulation scheme of the RB from reception data of the PDSCH area included in each of the wireless signals, and may estimate relationship information between the DCI and the RB based on the DCI within the PDCCH area and the RB within the PDSCH area.

For example, the control information obtaining apparatus may perform a first operation of verifying an RB of a PDSCH area corresponding to valid DCI in a PDCCH area of a serving cell; a second operation of verifying DCI not corresponding to the RB of the PDSCH area from DCI within the PDCCH area of the serving cell and an RB not corresponding to the DCI of the PDCCH area from RBs within the PDSCH area; a third operation of repeating the first operation and the second operation with respect to the plurality of cells; a fourth operation of verifying correspondence relationship between the DCI verified to not correspond and the RB verified to not correspond in the second operation, based on an RB allocation location included in the DCI verified to not correspond in the second operation; and a fifth operation of updating a field value of a carrier CIF per C-RNTI that allows the DCI including the CIF to be received during a data valid section of the wireless signals. Here, the DCI verified to not correspond and the RB verified to not correspond may be based on cross-carrier scheduling.

According to an example embodiment, the control information obtaining apparatus may estimate, as the scheduling information, a TBS that is a size of service data transferred through a PDSCH based on a number of RBs allocated to a terminal and a TBS index corresponding to the DCI of the PDCCH area included in each of the wireless signals. Here, the TBS index may be determined based on an MCS field value within the DCI, a modulation scheme of an RB, and information about an MCS table.

Information about the MCS table may be determined based on the modulation scheme of the RB. Also, if the MCS field value meets a predetermined condition, for example, if the MCS field value corresponds to 5˜9, 11˜16, and 20˜28, information about the MCS table may be determined based on the MCS field value and the modulation scheme of the RB. Also, information about the MCS table may be determined based on a weight applied to each of a plurality of MCS tables. Here, the weight may be determined based on at least one of at least one of a distribution rate and a use rate of a terminal supporting a specific modulation scheme; a size of a precoding index field of DCI; a number of retransmissions of a single RNTI during a plurality of sub-frame sections; and a distance between a base station and the terminal.

In operation 830, the control information obtaining apparatus obtains control information about a downlink of the plurality of cells based on the scheduling information. Here, the control information may include, for example, a current operation state of a cell, a current management state, and/or a statistical characteristic thereof as mobile communication service related data extracted from a downlink of a cell managed or operated by the base station.

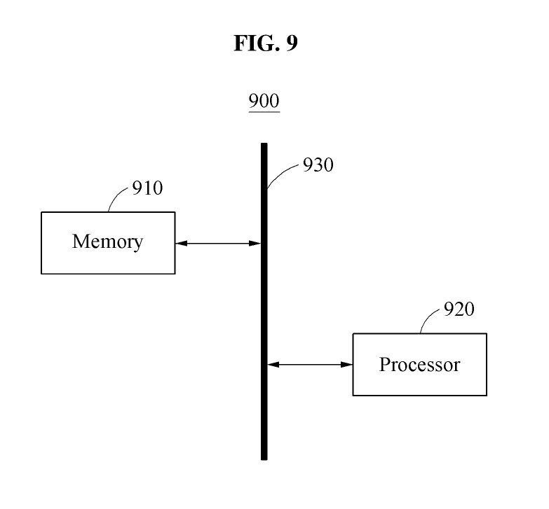

FIG. 9 is a diagram illustrating an example of a control information obtaining apparatus according to an example embodiment.

Referring to FIG. 9, a control information obtaining apparatus 900 includes a memory 910 and a processor 920. The memory 910 and the processor 920 may communicate with each other through a bus 930.

The memory 910 may include a computer-readable instruction. The processor 920 may perform the aforementioned operations in response to the instruction stored in the memory 910 being executed at the processor 920. The memory 910 may be a volatile memory or a non-volatile memory.

The memory 920 may be a device that executes instructions or programs or controls the control information obtaining apparatus 900. The processor 920 receives wireless signals corresponding to different center frequencies from a plurality of cells, estimates scheduling information from the wireless signals, and obtains control information about a downlink of the plurality of cells based on the scheduling information.

The control information obtaining apparatus 900 may perform the aforementioned operation.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

The example embodiments described herein may be implemented using hardware components, software components, and/or combination thereof. For example, the hardware components may include microphones, amplifiers, band-pass filters, audio to digital converters, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include plurality of processing elements and plurality of types of processing elements. For example, a processing device may include plurality of processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of obtaining control information, the method comprising:
receiving wireless signals corresponding to different center frequencies from a plurality of cells;
estimating scheduling information from the wireless signals; and
obtaining control information about a downlink of the plurality of cells based on the scheduling information.

2. The method of claim 1, wherein the estimating of the scheduling information comprises estimating relationship information between downlink control information (DCI) of a physical downlink control channel (PDCCH) area and a resource block (RB) of a physical downlink shared channel (PDSCH) area included in each of the wireless signals as the scheduling information.

3. The method of claim 2, wherein the estimating of the scheduling information comprises:
estimating DCI within the PDCCH area from reception data of the PDCCH area included in each of the wireless signals;
estimating at least one of occupancy or non-occupancy of an RB within the PDSCH area included in each of the wireless signals and a modulation scheme of the RB from reception data of the PDSCH area included in each of the wireless signals; and
estimating relationship information between the DCI and the RB based on the DCI within the PDCCH area and the RB within the PDSCH area.

4. The method of claim 2, wherein the estimating of the scheduling information comprises:
a first operation of verifying an RB of a PDSCH area corresponding to valid DCI in a PDCCH area of a serving cell;
a second operation of verifying DCI not corresponding to the RB of the PDSCH area from DCI within the PDCCH area of the serving cell and an RB not corresponding to the DCI of the PDCCH area from RBs within the PDSCH area;
a third operation of repeating the first operation and the second operation with respect to the plurality of cells; and
a fourth operation of verifying correspondence relationship between the DCI verified to not correspond and the RB verified to not correspond in the second operation, based on an RB allocation location included in the DCI verified to not correspond in the second operation.

5. The method of claim 4, wherein the estimating of the scheduling information further comprises:
a fifth operation of updating a field value of a carrier indicator field (CIF) per cell-radio network temporary identifier (C-RNTI) that allows the DCI including the CIF to be received during a data valid section of the wireless signals.

6. The method of claim 4, wherein the DCI verified to not correspond and the RB verified to not correspond are based on cross-carrier scheduling.

7. The method of claim 1, wherein the estimating of the scheduling information comprises estimating, as the scheduling information, a transport block size (TBS) that is a size of service data transferred through a PDSCH, based on a number of RBs allocated to a terminal and a TBS index corresponding to DCI of a PDCCH area included in each of the wireless signals.

8. The method of claim 7, wherein the TBS index is determined based on a modulation coding scheme (MCS) field value within the DCI, a modulation scheme of an RB, and information about an MCS table.

9. The method of claim 8, wherein information about the MCS table is determined based on the modulation scheme of the RB.

10. The method of claim 8, wherein information about the MCS table is determined based on the MCS field value and the modulation scheme of the RB if the MCS field value meets a predetermined condition.

11. The method of claim 8, wherein information about the MCS table is determined based on a weight applied to each of a plurality of MCS tables.

12. The method of claim 11, wherein the weight is determined based on at least one of:
at least one of a distribution rate and a use rate of a terminal supporting a specific modulation scheme;
a size of a precoding index field of DCI;
a number of retransmissions of a single RNTI during a plurality of sub-frame sections; and
a distance between a base station and the terminal.

13. A method of obtaining control information, the method comprising:
receiving wireless signals corresponding to different center frequencies from a plurality of cells;
estimating relationship information between downlink control information (DCI) of a physical downlink control channel (PDCCH) area and a resource block (RB) of a physical downlink shared channel (PDSCH) area included in each of the wireless signals; and
obtaining control information about a downlink of the plurality of cells based on the relationship information.

14. An apparatus for obtaining control information, the apparatus comprising:
a processor; and
a memory including at least one instruction executable by the processor,
wherein, when the at least one instruction is executed by the processor, the processor is configured to receive wireless signals corresponding to different center frequencies from a plurality of cells, to estimate scheduling information from the wireless signals, and to obtain control information about a downlink of the plurality of cells based on the scheduling information.

15. The apparatus of claim 14, wherein the processor is configured to estimate relationship information between downlink control information (DCI) of a physical downlink control channel (PDCCH) area and a resource block (RB) of a physical downlink shared channel (PDSCH) area included in each of the wireless signals as the scheduling information.

16. The apparatus of claim 15, wherein the processor is configured to estimate DCI within the PDCCH area from reception data of the PDCCH area included in each of the wireless signals, to estimate at least one of occupancy or non-occupancy of an RB within the PDSCH area included in each of the wireless signals and a modulation scheme of the RB from reception data of the PDSCH area included in each of the wireless signals, and to estimate relationship information between the DCI and the RB based on the DCI within the PDCCH area and the RB within the PDSCH area.

17. The apparatus of claim 14, wherein the processor is configured to estimate, as the scheduling information, a transport block size (TBS) that is a size of service data transferred to a PDSCH, based on a number of RBs allocated to a terminal and a TBS index corresponding to DCI of a PDCCH area included in each of the wireless signals.

18. The apparatus of claim 17, wherein the TBS index is determined based on a modulation coding scheme (MCS) field value within the DCI, a modulation scheme of the RB, and information about an MCS table.

19. The apparatus of claim 18, wherein information about the MCS table is determined based on the MCS field value and the modulation scheme of the RB if the MCS field value meets a predetermined condition.

20. The apparatus of claim 18, wherein information about the MCS table is determined based on a weight applied to each of a plurality of MCS tables.
